(19) United States
(12) Patent Application Publication
(10) Pub. No.: US 2005/0248942 A1
(43) Pub. Date: Nov. 10, 2005

(54) Internally illuminated fireplace mantle

(76) Inventor: Simonee Akstin Tierney, Warwick, NY (US)

Correspondence Address: DR. LUTHER CALVIN HARGIS, 40 MAPLE AVE., WARWICK, NY, 10990, US

(21) Appl. No.: 10/840,598

(22) Filed: May 7, 2004

(51) Int. Cl. F21V 1/00

(52) U.S. Cl. 362/240

(57) ABSTRACT

An internally illuminated mantle utilizing a light strip or similar series of small, low heat emitting bulbs placed inside the interior of a fireplace mantle having a top section of clear plate glass or other light transmissible surface, so that light from the interior of the mantle can be projected upward through the light transmissive or glass surface illuminating structures atop the mantle as well as the wall area above the mantle and providing illumination within the space or room in which the mantle resides.

### FIELD OF THE INVENTION

The present invention relates to a fireplace mantle that is internally illuminated with a light transmissive top and/or side that allows for the passage of light upward and outward to illuminate items atop the mantle and to illuminate the immediate area.

### BACKGROUND OF THE INVENTION

Devices having internal illumination including signs, work surfaces, light boxes, back lit pictures or cabinets have been known and patented for a number of years. These include, but are not limited to the references cited in this patent application.

The application of an internally illuminated fireplace mantle allowing for the passage of light through a light tranmissive top and/or sides will allow for a secondary source of light within a given area and will provide illumination for items atop the mantle and thus may be used as an interior decorating application as an enhancement to the decor of one's home.

### SUMMARY OF THE INVENTION

The present invention is an internally illuminated mantle with a light transmissive top and/or sides that allows for the passage of light from an internal light source such as strip light with a series of small low hear emitting bulbs connected to a standard electrical source and switch giving off a illumination which passes through light transmissive materials in the top and/or sides of the mantle.

Any number of small light emitting bulbs may be used as is commonly known to the industry such as strip lighting or other light emitting sources. The illumination should be provided by a low heat-emitting source and connected to an electric circuit and switch. A rheostat device to allow for the regulation of illumination throughout the spectrum from very dim lighting to very bright/intense lighting is best used to vary the effect of the lighting.

Thus items atop the mantle and in the general area will be lit with an intensity desired by the user to provide an enhancement for objects or wall surfaces in the immediate area atop the mantle and upon the walls as a interior-decorating enhancement.

### OBJECT OF THE INVENTION

The principal object of the present invention is to provide an illuminated mantle with passage of light from an internal light strip through a light transmissive top and or sides for illumination of items atop the mantle and the immediate area.

Another object of this invention is to provide a secondary source of illumination for a given space.

A further objective of this invention is to provide a decorating aspect and enhancement for the purposes of augmenting interior decoration.

### DRAWINGS

FIG. 1: Is a frontal and slightly downward view of a section of mantle, demonstrating the positioning of the light strip and light transmissive top.

FIG. 2: Is a frontal and lightly downward view of the mantle atop a fireplace, demonstrating the passage of light through a light transmissive top.

FIG. 3: Is a frontal and slightly inferior view of the front and undersurface of a fireplace mantle.

### DETAILED DESCRIPTION OF DRAWINGS

The present invention is a device allowing for the internal illumination of a fireplace mantle allowing for the transmission of light through a light transmissive top or side surface for the purposes of illuminating items atop the mantle and the general area.

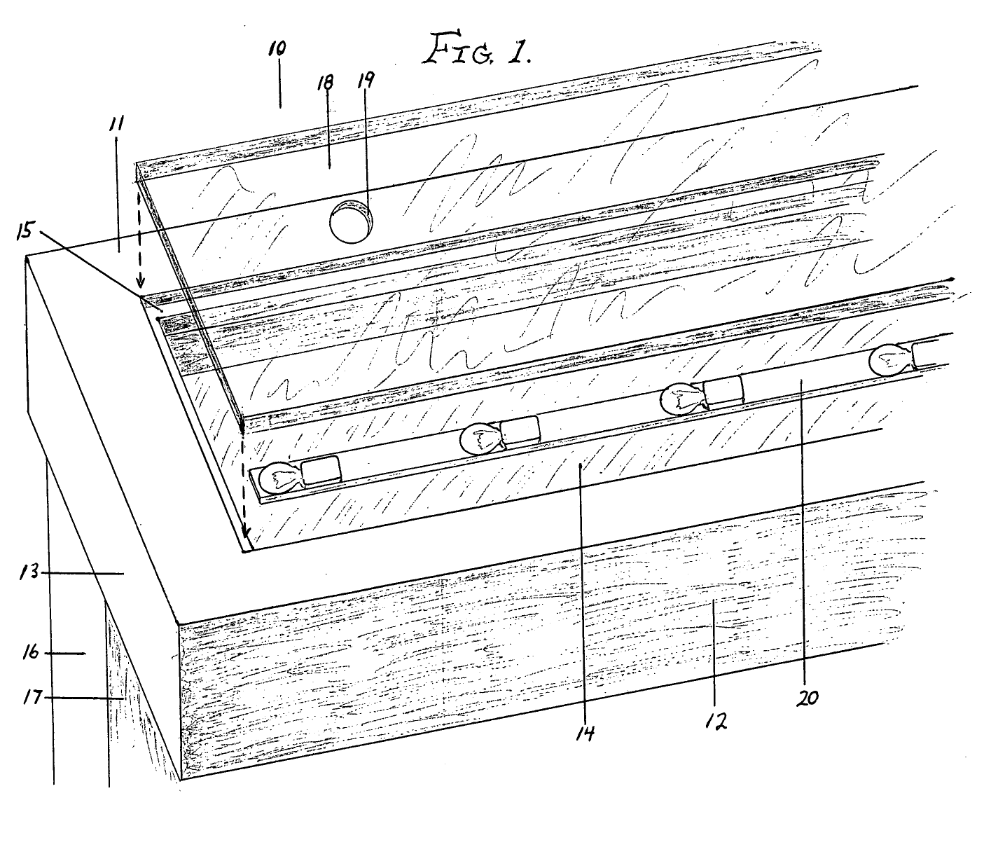

Referring to the drawings and particularly FIG. 1, we see a frontal and slightly downward view of a left portion of mantle number ten as in facing the mantle. This mantle made of wood or other material, having a top number 11, a left side number 13, and a front side number 12, placed upon a base crosspiece, having a side 16 and front 17.

The top of mantle 10, having a rabbeted area number 15, allowing for the seating of a piece of plate glass or other light transmissive material, 18, which in this case has a circular hole, 19 viewed in its left portion and a similar hole which would be situated in the opposite end, allowing for lifting purposes facilitating the ease of removal of the light transmissive top as a means of approaching the light strip or other lighting device.

The mantle of FIG. 1, having a cavity or internal portion number 14, with attachment of a light strip to the bottom of the internal portion designated by number 20.

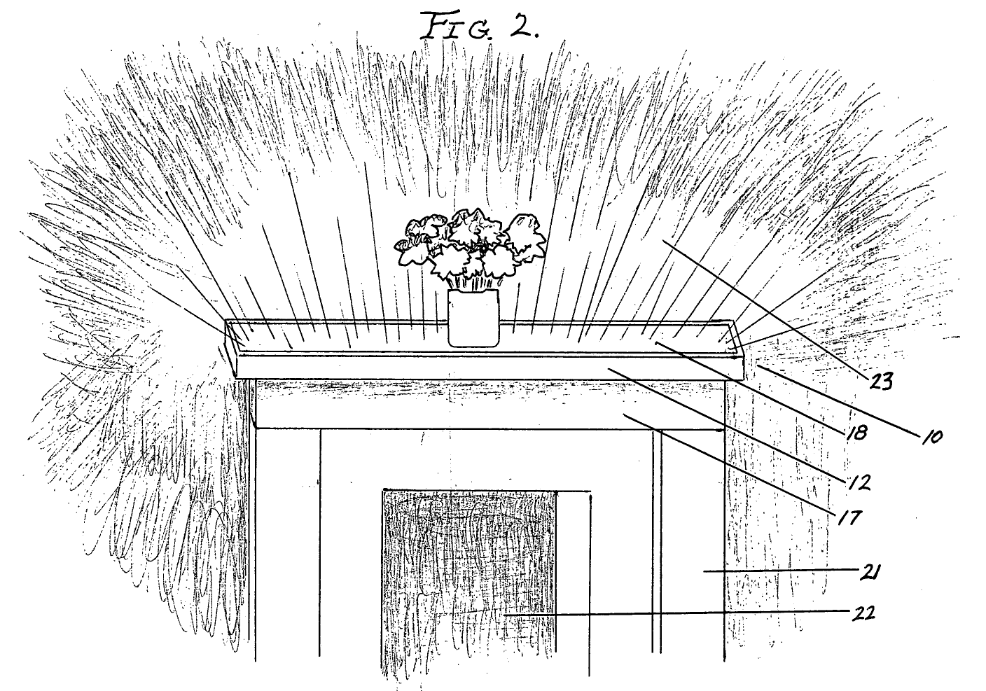

FIG. 2 is a frontal view of the mantle, number 10 situated atop a cross piece 17 and a leg or base of the mantle 21. Seen is the interior of the fireplace 22, the front of the mantle 12, a light transmissive top 18, and the illumination coming from the mantle itself, designated 23.

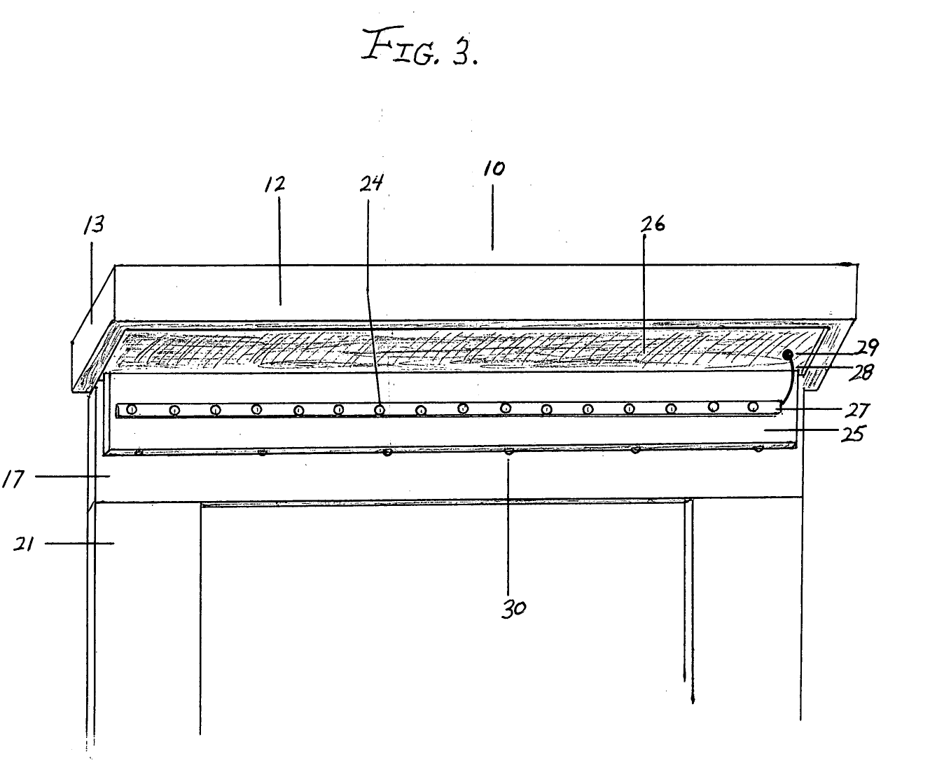

FIG. 3 is a frontal and slightly inferior view of the mantle seen as 10 with a side 13, and a front 12. Having an interior portion 26, and a hinged door 25 with a light strip numbered 27 attached to the door with individual light bulbs 24, and a standard electric chord 28 with an opening passing through the rear portion of the mantle 29. The mantle has its crosspiece 17 and base or pedestal 21. In addition the door holding the light strip is seen to have periodic spring closure devices 30 which are standard and commonly known to the industry and one of the many ways that might be used to access the cavity/light strip. Such means as light strip mounted to a hinged lower door would facilitate changing spent bulbs or other optical lighting mechanisms. Such means would be at the discretion of the maker and apart from the spirit and intent of this design.

### SUMMARY OF THE ACHEIVEMENT OF THE OBJECTS OF THE INVENTION

From the foregoing it is readily apparent that I have invented an internally illuminated fireplace mantle with a light transmissive top and/or sides allowing for the passage of light through the transmissive materials to illuminate objects atop the mantle and the general vicinity. The methods of manufacture and materials used for the mantle may vary greatly as can the particular light source within the mantle.

The methods for reaching that light source including the removal of a light transmissive top set into a ‘rabbited’ groove or perhaps by a hinged door at the underside of the mantle are just two means either of which can be used to access the light strip and would depend on the manufacturing source and the desire of the maker. However, standard opening and closures known within the cabinetry and manufacturing industry could be utilized to access the lighting in any number of methods.

The given applications should not be construed to limit the methods and/or techniques used in the manufacture of the mantle and the defining aspect of the invention is any methods allowing for the internal illumination of the mantle and its ability to transmit light through a light transmissible surface and or sides. Internal illumination might also include any illuminating optical mechanism and/or reflector system that allows for generation of light through a light transmissible top and/or sides.

It is to be understood that the foregoing description and specific embodiments are merely illustrated of the best mode of the invention and the principal thereof and that various modifications and additions may be made to the apparatus by those skilled in the art, without departing from the spirit and the scope of this invention.

1. A fireplace mantle having internal illumination and possessing a light transmissive top and or sides producing illumination of items atop the mantle, illumination of the wall above and portions of the area or room wherein the mantle resides.

2. A mantle according to claim 1 having internal illumination by means of a light strip or series of low heat emitting small bulbs producing sufficient illumination through the light transmissive top or sides and connected electrically through the rear portion of the mantle to an electrical circuit/switch/rheostat device for regulating the intensity of the light and for switching the light on and off as is commonly understood within the industry and used for electric supply of lamps and lighting devices.

3. The mantle according to claim 1 possessing a light transparent top sitting flush and downward into the mantle itself by means of a ‘rabbited’ groove or other means left to the discretion of the manufacturer/carpenter.
